(19) United States
(12) Patent Application Publication
(10) Pub. No.: US 2026/0067240 A1
(43) Pub. Date: Mar. 5, 2026

(54) HARDWARE-BASED ACCELERATING APPARATUS FOR NVME OVER FABRICS TARGET, OPERATION METHOD THEREOF, AND SYSTEM INCLUDING THE SAME

(71) Applicant: MangoBoost, Inc., Bellevue, WA (US)

(72) Inventors: Kyeongsu YUN, Seoul (KR); Sejin KIM, Seoul (KR); Wonsik LEE, Seoul (KR); Dongju CHAE, Seoul (KR); Bongwon LEE, Seoul (KR)

(21) Appl. No.: 19/301,755

(22) Filed: Aug. 15, 2025

(30) Foreign Application Priority Data
Aug. 27, 2024 (KR) 10-2024-0114812
Jan. 10, 2025 (KR) 10-2025-0003875

(51) Int. Cl. H04L 49/9047

(52) U.S. Cl. CPC H04L 49/9047

(57) ABSTRACT

A non-volatile memory express over fabrics (NVMe-oF) target accelerating apparatus according to an embodiment of the present disclosure includes: a first offload engine configured to offload a network stack to compute a first network packet and output a first packet payload; and a second offload engine configured to offload an NVMe-oF stack to compute the first packet payload and output data having a first buffer address when the first packet payload is of a first type.

### CROSS-REFERENCE TO RELATED APPLICATION(S)

This application claims benefit of priority to Korean Patent Application Nos. 10-2024-0114812, filed on Aug. 27, 2024, and 10-2025-0003875, filed on Jan. 10, 2025, in the Korean Intellectual Property Office, the disclosures of which are incorporated herein by reference in their entirety.

### BACKGROUND

### Technical Field

The present disclosure relates to a high-performance storage network, and more particularly, to a hardware-based accelerating apparatus for an NVMe-oF target, an operation method thereof, and a system including the same.

### Description of the Related Art

NVMe over Fabrics (NVMe-oF) technology has been developed to extend non-volatile memory express (NVMe), which is optimized for solid state drive (SSD) interfaces (protocols), to the network domain. Using the NVMe-oF protocol, it is possible to connect to or access remote NVMe devices (SSDs) via various networks.

However, to process access requests to SSDs included in targets such as servers, the use of a central processing unit (CPU) increases, which may degrade overall processing performance.

### BRIEF SUMMARY

The present disclosure provides a hardware-based accelerating apparatus for an NVMe-oF target, an operation method thereof, and a system including the same, capable of improving data processing performance.

An NVMe-oF target accelerating apparatus according to an embodiment of the present disclosure includes, a first offload engine configured to offload a network stack to compute a first network packet and output a first packet payload; and a second offload engine configured to offload an NVMe-oF stack to compute the first packet payload and output data having a first buffer address when the first packet payload is of a first type.

A method of operating an NVMe-oF target accelerating apparatus according to an embodiment of the present disclosure includes, receiving, by a first offload engine, a first network packet for a storage device to output a first packet payload; and extracting, by a second offload engine, a command capsule from the first packet payload, and storing data of the first packet payload in a region corresponding to the first buffer address of a data buffer when the first packet payload is of a first type.

A system including an NVMe-oF target accelerating apparatus according to an embodiment of the present disclosure includes, an NVMe-oF target accelerating apparatus including a first offload engine configured to offload a network stack to compute a network packet and output a first packet payload, and a second offload engine configured to offload an NVMe-oF stack to compute the first packet payload and output data having a first buffer address when the first packet payload is of a first type; and a plurality of storage devices configured to perform input/output corresponding to the first SQE and provide an input/output result to the NVMe-oF target accelerating apparatus as a first CQE.

According to a hardware-based NVMe-oF target accelerating apparatus, an operation method thereof, and a system including the same according to an embodiment of the present disclosure, processing performance can be improved while reducing CPU usage by including a first offload engine and a second offload engine.

Alternatively, according to a hardware-based NVMe-oF target accelerating apparatus, an operation method thereof, and a system including the same according to an embodiment of the present disclosure, a second offload engine sequentially processes packet payloads in the order received from a first offload engine regardless of the completion of reception of all data related to one command, thereby improving processing performance. Alternatively, according to a hardware-based NVMe-oF target accelerating apparatus, an operation method thereof, and a system including the same according to an embodiment of the present disclosure, processing performance can be improved by a second offload engine delivering the response payload when a first offload engine is capable of processing. Alternatively, according to a hardware-based NVMe-OF target accelerating apparatus, an operation method thereof, and a system including the same according to an embodiment of the present disclosure, processing performance can be improved as a second offload engine can sequentially process related data even if network packets for different network sessions are delivered intermingled.

Alternatively, according to a hardware-based NVMe-oF target accelerating apparatus, an operation method thereof, and a system including the same according to an embodiment of the present disclosure, processing performance can be improved by sequentially processing in the order of received packet payloads even if network packets of different network sessions are provided intermingled to a second offload engine.

Alternatively, according to a hardware-based NVMe-oF target accelerating apparatus, an operation method thereof, and a system including the same according to an embodiment of the present disclosure, processing performance can be improved by efficiently performing addressing to the data buffer by converting a command identifier.

Alternatively, according to a hardware-based NVMe-OF target accelerating apparatus, an operation method thereof, and a system including the same according to an embodiment of the present disclosure, traffic in the process of delivering SQEs to a storage device can be reduced by updating a SQ doorbell when n SQEs are stored in one submission queue. Alternatively, according to a hardware-based NVMe-oF target accelerating apparatus, an operation method thereof, and a system including the same according to an embodiment of the present disclosure, traffic in the process of delivering a CQ doorbell to a storage device can be reduced by updating the CQ doorbell when m CQEs are processed in one completion queue.

The effects obtainable from the exemplary embodiments of the present disclosure are not limited to those mentioned above, and other effects not described herein can be clearly derived and understood from the following description by those skilled in the art to which the exemplary embodiments of the present disclosure pertain. In other words, unintended effects resulting from the implementation of the exemplary embodiments of the present disclosure can also be derived by those skilled in the art to which the present disclosure pertains.

### BRIEF DESCRIPTION OF THE SEVERAL VIEWS OF THE DRAWINGS

FIG. 1 is a diagram illustrating an NVMe-oF target accelerating apparatus according to an embodiment of the present disclosure.

FIGS. 2 to 4 are diagrams each illustrating a system including the NVMe-oF target accelerating apparatus according to an embodiment of the present disclosure.

FIG. 5 is a diagram illustrating a format of a command capsule on a NVMe-oF protocol.

FIG. 6 is a diagram illustrating a second offload engine according to an embodiment of the present disclosure.

FIGS. 7A to 7G are diagrams explaining an operation of the second offload engine processing a packet payload according to an embodiment of the present disclosure.

FIG. 8 is a diagram illustrating a system including the NVMe-oF target accelerating apparatus according to an embodiment of the present disclosure.

FIGS. 9A to 9C are diagrams each illustrating an NVMe-oF target accelerating apparatus according to an embodiment of the present disclosure.

### DETAILED DESCRIPTION

Hereinafter, embodiments of the present disclosure will be described in detail with reference to the drawings so that those skilled in the art to which the present disclosure pertains can easily implement the present disclosure. However, the present disclosure can be implemented in various different forms and is not limited to the embodiments described herein.

In describing the drawings, identical or similar components may be denoted by identical or similar reference numerals. In addition, in the drawings and related descriptions, descriptions of well-known functions and configurations may be omitted for clarity and conciseness.

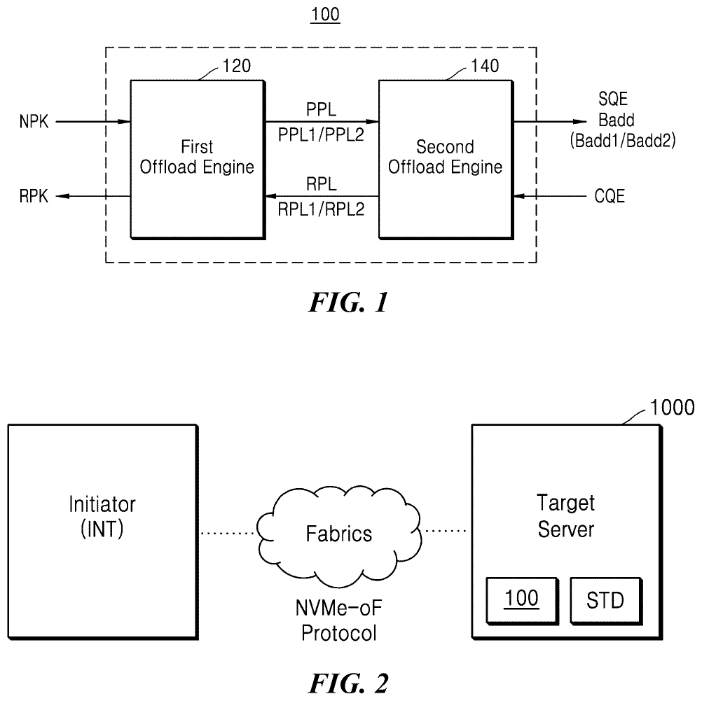

FIG. 1 is a diagram illustrating an NVMe-oF target accelerating apparatus 100 according to an embodiment of the present disclosure, and FIGS. 2 to 4 are diagrams each illustrating a system 1000 including the NVMe-oF target accelerating apparatus 100 according to an embodiment of the present disclosure.

Referring to FIGS. 1 to 4, the NVMe-oF target accelerating apparatus 100 according to an embodiment of the present disclosure accelerates an access operation of a storage device (STD) between network nodes connected to a network such as a fabric. The NVMe-OF target accelerating apparatus 100 according to an embodiment of the present disclosure may be provided in the form of a chip, a card, or a module.

The storage device (STD) may be a Solid State Drive (SSD) that is a Non-volatile memory (NVM). The system 1000 including the NVMe-OF target accelerating apparatus 100 according to an embodiment of the present disclosure is a kind of network node, and FIG. 2 illustrates an example in which the system 1000 according to an embodiment of the present disclosure is a target server. However, it is not limited thereto.

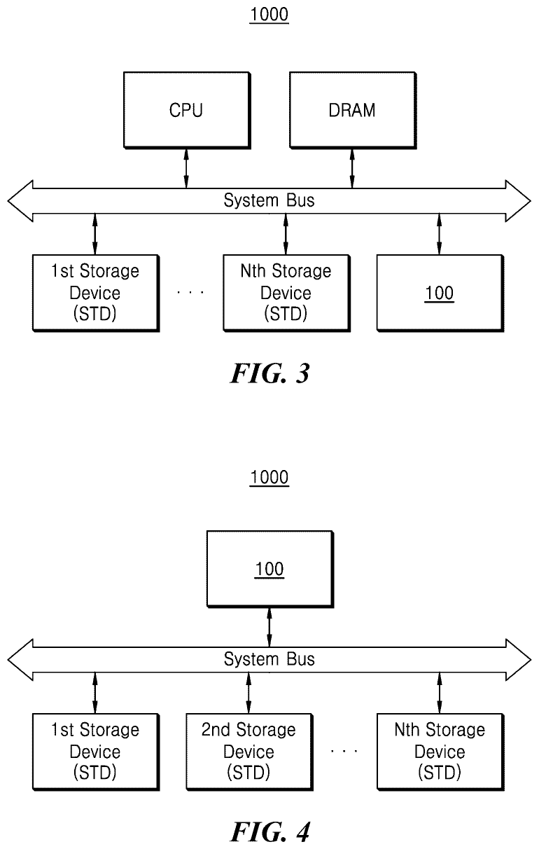

The system 1000 according to an embodiment of the present disclosure may include n storage devices (STDs), a CPU, a system memory (DRAM), and the NVMe-oF target accelerating apparatus 100 connected to a system bus, as shown in FIG. 3. The system bus may operate according to the peripheral component interconnect express (PCIe) standard, but is not limited thereto.

The CPU may initialize the storage devices (STDs) and the NVMe-OF target accelerating apparatus 100 and be in charge of processing related to control.

FIG. 3 illustrates a dynamic random-access memory (DRAM) as a system memory. The system memory may be used as a data buffer for the NVMe-OF target accelerating apparatus 100, which will be described later, to store submission queue entries (SQEs), completion queue entries (CQEs), and data.

The system memory may include a submission queue and a completion queue corresponding to each storage device (STD) to store SQEs and CQEs.

In one embodiment, a pair of submission queue and completion queue may be provided for one storage device (STD). In one embodiment, two or more pairs of submission queues and completion queues may be provided for one storage device (STD).

In the present disclosure, unless it is necessary to clearly distinguish, SQE may be used interchangeably with command or CQE may be used interchangeably with completion.

Alternatively, the system 1000 according to an embodiment of the present disclosure may include n storage devices (STDs) and the NVMe-OF target accelerating apparatus 100 connected to a system bus, as shown in FIG. 4. In the system of FIG. 4, the NVMe-oF target accelerating apparatus 100 may include a built-in processor and a data buffer. The data buffer built in the NVMe-oF target accelerating apparatus 100 may include a region for storing data and a region for providing a submission queue and a completion queue, as the system memory of FIG. 3.

Although not shown, the system 1000 according to an embodiment of the present disclosure may include both the system memory of FIG. 3 and the data buffer in the NVMe-OF target accelerating apparatus 100. In this case, data may be stored in the system memory, and SQEs and CQEs may be stored in a separate data buffer in the NVMe-OF target accelerating apparatus 100.

Hereinafter, unless otherwise specified, the NVMe-oF target accelerating apparatus 100 or the system 1000 according to an embodiment of the present disclosure may include a data buffer in one of the various ways described above. Alternatively, the NVMe-oF target accelerating apparatus 100 or the system 1000 according to an embodiment of the present disclosure may include a data buffer in a manner different from that described above.

In one embodiment, an initiator (INT), which is another network node, may transmit a network packet (NPK) including an I/O command of read, write, or flush, or an admin command related to queue management or namespace management, or a fabrics command related to NVMe-oF connection establishment or NVMe-oF target attribute setting according to an NVMe-oF protocol to access the storage device (STD) of the system 1000 according to an embodiment of the present disclosure.

The system 1000 may process the network packet (NPK) and transmit it to the initiator (INT) as a response packet (RPK). In one embodiment, the system 1000 may transmit the response packet (RPK) including read data to the initiator (INT) according to the NVMe-oF protocol in response to a read request (read command) for the storage device (STD).

The NVMe-oF target accelerating apparatus 100 and the system 1000 including the same according to embodiments of the present disclosure may improve the packet or data processing performance of the NVMe-oF target accelerating apparatus 100 and the system 1000 by minimizing CPU usage and quickly processing network packets (NPKs), thereby achieving high capacity and high speed. Furthermore, high-capacity and high-speed packet or data transmission and reception may be smoothly performed on the network.

To this end, the NVMe-oF target accelerating apparatus 100 according to an embodiment of the present disclosure includes a first offload engine 120 and a second offload engine 140.

The first offload engine 120 may offload a network stack to compute a network packet (NPK) and output a packet payload (PPL). The network packet (NPK) may include a header according to a network protocol and a command capsule according to the NVMe-oF protocol.

The first offload engine 120 may be hardware that offloads a transmission control protocol/internet protocol (TCP/IP) stack or a remote direct memory access over converged ethernet (RoCE) stack as a network stack. Alternatively, the first offload engine 120 may support both TCP/IP and ROCE. Alternatively, the first offload engine 120 may support other network protocols in addition to TCP/IP and RoCE.

In the case of the network packet (NPK) of TCP/IP, the first offload engine 120 may perform operations such as header removal, error detection and retransmission, and flow control on the network packet (NPK). In the case of the network packet (NPK) of ROCE, the first offload engine 120 may perform operations such as header removal and queue pair management on the network packet (NPK).

In one embodiment, the first offload engine 120 may process a network packet (NPK) received at an arbitrary time t1 and output a first packet payload (PPL1) at an arbitrary time t2. In one embodiment, the first offload engine 120 may process a network packet (NPK) received at an arbitrary time t3 and output a second packet payload (PPL2) at an arbitrary time t4.

The arbitrary time t3 may be a time preceding or following the arbitrary time t2. The first packet payload (PPL1) and the second packet payload (PPL2) may be packet payloads for network packets (NPKs) of the same network session or packet payloads for network packets (NPKs) of different network sessions.

The packet payload (PPL) output from the first offload engine 120 may be provided to the second offload engine 140. In one embodiment, the first packet payload (PPL1) output from the first offload engine 120 at an arbitrary time t2 and the second packet payload (PPL2) output at an arbitrary time t4 may be provided to the second offload engine 140).

When the packet payload (PPL) is provided to the second offload engine 140, the first offload engine 120 may provide packet metadata including a network identifier, which is an identifier for a network session, together.

The second offload engine 140 may offload the NVMe-oF stack to compute the packet payload (PPL) provided from the first offload engine 120. The packet payload (PPL) may be one of a first type and a second type. The first type of packet payload (PPL) may include data in the command capsule, and the second type of packet payload (PPL) may include only a command in the command capsule.

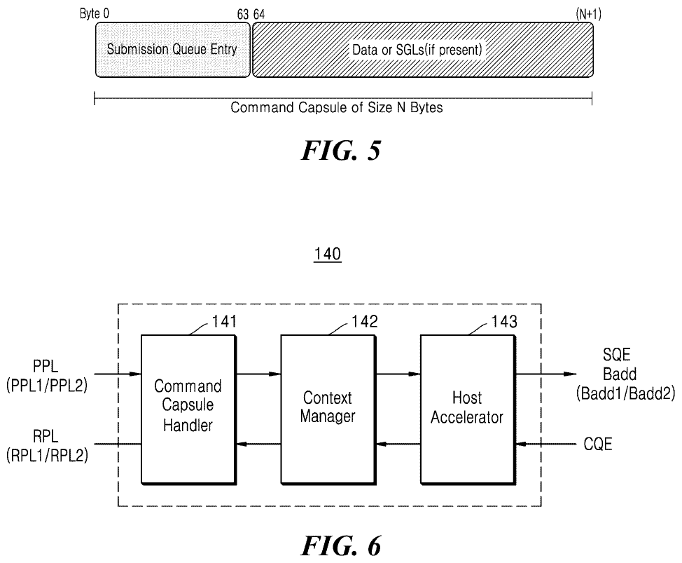

FIG. 5 is a diagram illustrating a format of a command capsule on the NVMe-oF protocol.

Referring to FIG. 5, n bytes command capsule is in a format defined by the NVMe-OF protocol for accessing a remote SSD, and may include an SQE and optionally include data or a scatter-gather list (SGL). The size of the SQE is 64 bytes, and may include an admin command, a fabric command, or an I/O command.

In the case of I/O command, the SQE may include an Opcode indicating the type of the command (for example, “write( )” is “01h,” “read( )” is “02h”), a flag indicating additional control information for command execution, and a command identifier (CID) indicating a unique value among commands being executed in the submission queue, a namespace identifier (NSID) to which the command is applied, a metadata pointer (MPTR) indicating a physical address of metadata, a data pointer (DPTR) indicating an address of a buffer set in the form of a physical region page (PRP) or SGL and used for data transmission, and additional information required by the command.

Referring back to FIG. 1, in one embodiment, the first packet payload (PPL1) or the second packet payload (PPL2) may be a first type of packet payload that includes only data or includes data and a command (in other words, SQE). Alternatively, the first packet payload (PPL1) or the second packet payload (PPL2) may be a second type of packet payload that is composed of only all or part of the SQE.

The second offload engine 140 may output data having a unique buffer address (Badd) when the packet payload (PPL) is of the first type. In one embodiment, the second offload engine 140 may output data having a first buffer address (Badd1) when the first packet payload (PPL1) is a first type of packet payload. Similarly, the second offload engine 140 may output data having a second buffer address (Badd2) when the second packet payload (PPL2) is a first type of packet payload.

FIG. 6 is a diagram illustrating the second offload engine 140 according to an embodiment of the present disclosure.

Referring to FIGS. 1 and 6, the second offload engine 140 according to an embodiment of the present disclosure may include a command capsule handler 141, a context manager 142, and a host accelerator 143.

The command capsule handler 141 may output identification information including a command identifier of the command capsule. As described above, the SQE of the command capsule includes a command identifier, and the command capsule handler 141 may extract the command identifier from the SQE. When data for the same command, in other words, data constituting a command capsule together with one SQE, is included in two or more packet payloads (PPLs), the command identifiers for the two or more packet payloads (PPLs) may be the same.

The identification information may further include a network identifier and an offset for the data in addition to the command identifier. As described above, the network identifier may be extracted from the packet metadata delivered to the second offload engine 140 together with the packet payload (PPL).

The context manager 142 may generate a unique buffer address (Badd) for each packet payload (PPL) based on the identification information when the packet payload (PPL) is a first type of packet payload. In one embodiment, when the first packet payload (PPL1) is a first type of packet payload, the context manager 142 may generate a first buffer address (Badd1) for the first packet payload (PPL1) based on the identification information delivered from the command capsule handler 141. However, some of the identification information may be delivered to the context manager 142 by a functional block or logic other than the command capsule handler 141. Similarly, when the second packet payload (PPL2) is a first type of packet payload, the context manager 142 may generate a second buffer address (Badd2) for the second packet payload (PPL2) based on the identification information delivered from the command capsule handler 141.

The context manager 142 may generate a unique buffer address (Badd) for each packet payload (PPL) using the converted command identifier. At this time, the context manager 142 may convert the x bit (x is an integer of 2 or more) command identifier to a size smaller than x bits. In one embodiment, the context manager 142 may convert the command identifier to a value corresponding to the size of the submission queue and unique to each command to generate a unique buffer address for each packet payload (PPL). In other words, the command identifier may be set to any unique value less than or equal to the size of the submission queue.

In one embodiment, the context manager 142 may generate a first buffer address (Badd1) by converting the command identifier to a value corresponding to the depth of the submission queue in which the SQE of the command capsule is stored for the first packet payload (PPL1). As described above, the context manager 142 may further use a network identifier, an offset, and the like together with the converted command identifier in generating a unique buffer address for each packet payload (PPL).

The host accelerator 143 may provide the data of the packet payload (PPL) to a region of the data buffer (DBF) corresponding to the buffer address (Badd). In one embodiment, when the first packet payload (PPL1) is of the first type, the host accelerator 143 may provide the data of the first packet payload (PPL1) to a region of the data buffer corresponding to the first buffer address (Badd1). The same applies to the second packet payload (PPL2).

Hereinafter, the operation of generating the buffer address (Badd) according to an embodiment of the present disclosure will be described in more detail.

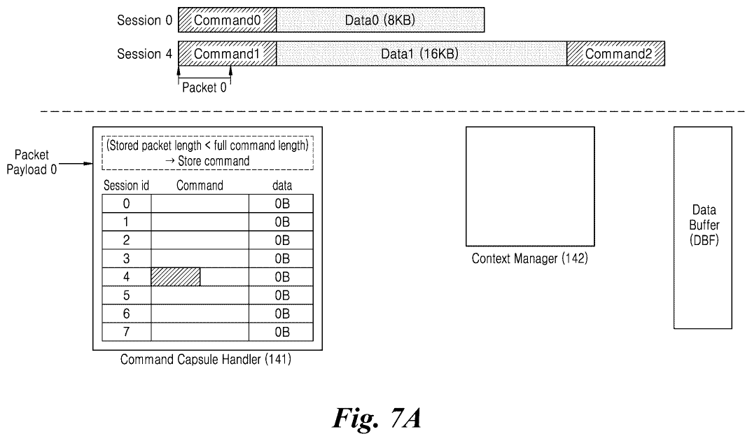

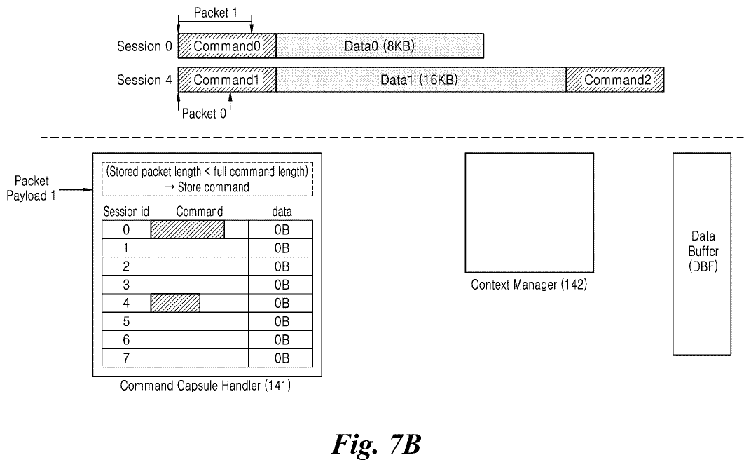

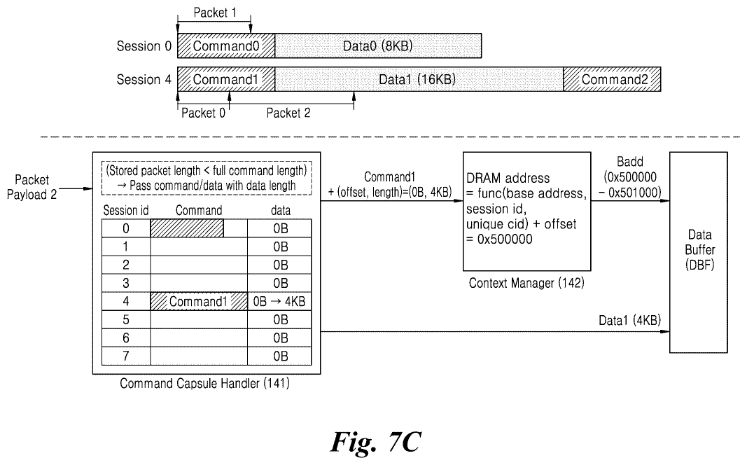

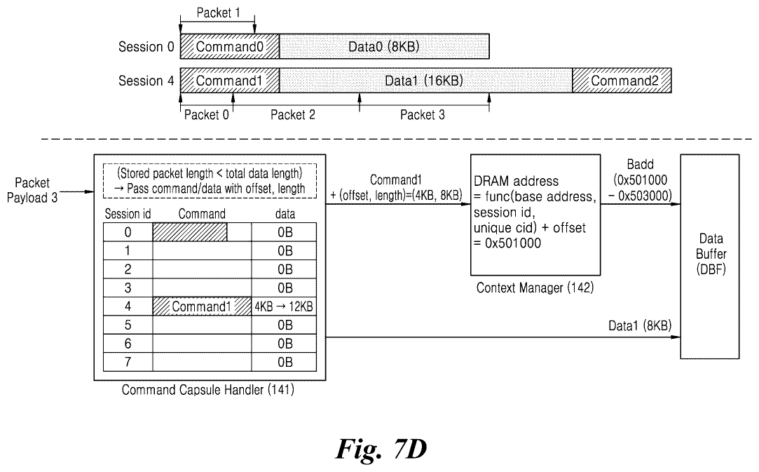

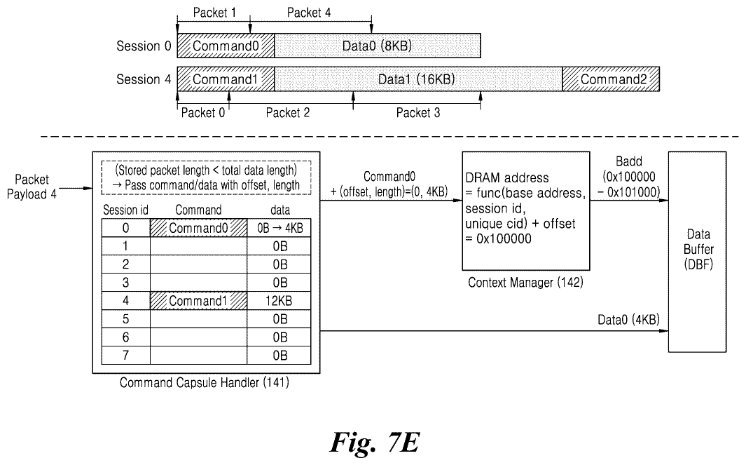

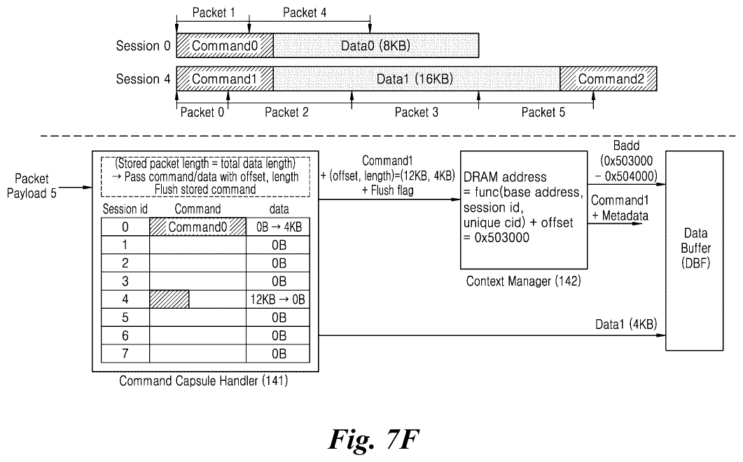

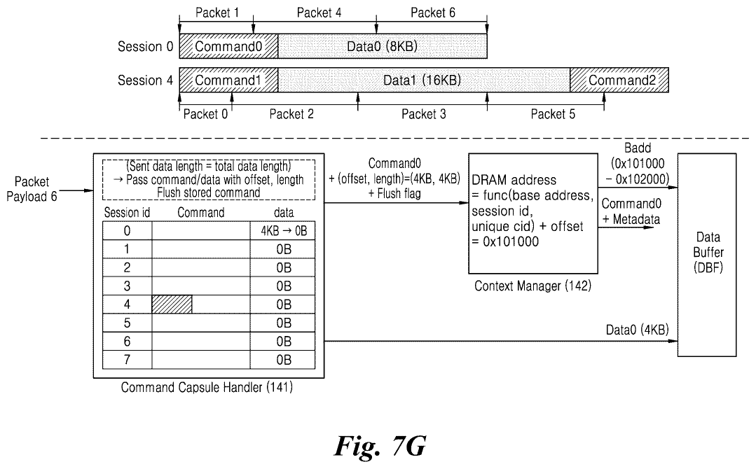

FIGS. 7A to 7G are diagrams for explaining an operation of the second offload engine 140 processing a packet payload (PPL) according to an embodiment of the present disclosure.

First, referring to FIGS. 1, 2, 6, and 7A, the first offload engine 120 may receive network packet 0 of network session 4 and output packet payload 0. Packet payload 0 may be a second type of packet payload including only a command. The command capsule handler 141 of the second offload engine 140 may store a part of command 1 from packet payload 0 in a handling table (HTB).

The handling table (HTB) included in the command capsule handler 141 may include a command field and a data field for storing information about the command and data of the packet payload (PPL). The handling table (HTB) may store information about corresponding commands and data by differentiating indexes for each network session. FIG. 7A illustrates an example in which session identifiers (session IDs) are set from network session 0 to network session 7, respectively, and a command field and a data field are allocated for each network session. The same applies hereinafter.

The command of the command capsule may be stored in the command field. In one embodiment, the SQE of the command capsule may be stored in the command field. Information about the data stored in the data field may include an offset for the data. The offset for the data may correspond to the data size of the packet payload (PPL) processed for the command stored in the command field of the handling table (HTB). The data field for each network session may be initialized with an offset “0.”

FIG. 7A illustrates an example in which a part of command 1 included in packet payload 0 is stored in the command field of the handling table (HTB) allocated to network session 4, and the initial offset for data is set to “0” in the data field.

Next, referring to FIGS. 1, 2, 6, and 7B, after receiving network packet 0 of network session 4, the first offload engine 120 may receive network packet 1 of network session 0 and output packet payload 1. Packet payload 1 may be a second type of packet payload including only a command. The command capsule handler 141 of the second offload engine 140 may store the command of packet payload 1 in the handling table (HTB). FIG. 7B illustrates an example in which a part of command 0 included in packet payload 1 is stored in the command field of the handling table (HTB) allocated to network session 0.

Next, referring to FIGS. 1, 2, 6, and 7C, after receiving network packet 1 of network session 0, the first offload engine 120 may receive network packet 2 of network session 4 and output packet payload 2. Packet payload 2 may be a first type of packet payload including data together with a command. The command capsule handler 141 of the second offload engine 140 may store information about the command and data of packet payload 2 in the handling table (HTB).

FIG. 7C illustrates an example in which the remaining part of command 1 included in packet payload 2 is stored in the command field of the handling table (HTB) allocated to network session 4 so as to be added, and the data field is updated from offset “0” to the data size “4 kB” of packet payload 2.

Since command 1 is completely stored in the command field of the handling table (HTB), the command capsule handler 141 may deliver command 1 and offset “0” to the context manager 142. The command capsule handler 141 may process that command 1 is completely stored in the command field when the size of the command stored in the command field is greater than or equal to a preset size. The preset size may vary depending on the protocol, and may be set to the size of the SQE in the case of the RDMA protocol and the size of the SQE and the NVMe-oF header in the case of the TCP protocol.

The command identifier may be included in command 1. The statement that the command identifier is included in command I may be the same as that the command identifier is included in the SQE of command 1. The network identifier may be provided to the context manager 142 by the command capsule handler 141. However, the present disclosure is not limited thereto, and the network identifier may be provided to the context manager 142 from the first offload engine 120 without passing through the command capsule handler 141. The command capsule handler 141 may provide information about the data size (4 kB) of packet payload 2 to the context manager 142 together with the offset “0.”

The context manager 142 may generate a buffer address (Badd) for packet payload 2 based on the identification information. As described above, when the identification information includes a network identifier, a command identifier, and an offset for data, the context manager 142 may generate a buffer address (Badd) for packet payload 2 based on the network identifier, the command identifier, and the offset.

As described above, the context manager 142 may convert the command identifier to a value corresponding to the depth of the submission queue to generate a buffer address (Badd). In the NVMe-oF protocol, the command identifier may be set to 16 bits, and the context manager 142 converts the command identifier to a small value corresponding to the size of the submission queue, so that the converted command identifier may be used as a buffer address (Badd) for a packet payload (PPL) optimized for the size of a network packet (NPK). In FIG. 7C, the command identifier converted by the context manager 142 is shown as “unique cid.” The same applies hereinafter.

In one embodiment, the context manager 142 may generate “0x500000” as a buffer address (Badd) for packet payload 2 based on the network identifier, the converted command identifier, and the offset. According to one embodiment, the context manager 142 may reflect a base address in the buffer address (Badd). The base address may be an address commonly allocated to network sessions or allocated to each network session in an initialization operation for the data buffer (DBF).

The host accelerator 143 may provide the data of packet payload 2 to a corresponding region of the data buffer (DBF) based on the buffer address (Badd). In the case of the embodiment of FIG. 7C, the host accelerator 143 may store the data of packet payload 2 at address “0x500000” of the data buffer (DBF) indicated by data identifier “0x500000.” The data buffer (DBF) may be provided as a DRAM.

Although not shown, the second offload engine 140 may further include a storage space such as a register capable of storing or maintaining data of packet payload 2 and/or related information until the context manager 142 generates a buffer address (Badd) for the data of packet payload 2 and delivers the buffer address (Badd) to the host accelerator 143. The same applies hereinafter.

Next, referring to FIGS. 1, 2, 6, and 7D, after receiving network packet 2 of network session 4, the first offload engine 120 may receive network packet 3 of network session 4 and output packet payload 3. Packet payload 3 may be a first type of packet payload made up of only data. The command capsule handler 141 of the second offload engine 140 may store information about the data of packet payload 3 in the handling table (HTB).

FIG. 7D illustrates an example in which information about the size “8 kB” of the data included in packet payload 3 is additionally reflected in the data field of the handling table (HTB) allocated to network session 4. The data field of the handling table (HTB) may be updated from offset “4 kB” to “12 kB.” As a result, information about the size of data provided to the second offload engine 140 in relation to command 1, in other words, the sum “12 kB” of data 4 kB of packet payload 2 and data 8 kB of packet payload 3, may be stored in the data field of the handling table (HTB).

The command capsule handler 141 may provide the context manager 142 with identification information corresponding to packet payload 3 and the data size of packet payload 3. In one embodiment, the command capsule handler 141 may provide the context manager 142 with only information excluding information that is the same as the identification information for packet payload 2. In one embodiment, the command capsule handler 141 may not provide the context manager 142 with command I already provided in relation to packet payload 2 for packet payload 3.

The context manager 142 may generate a buffer address (Badd) for packet payload 3 based on the identification information. FIG. 7D illustrates an example in which the context manager 142 generates “0x50100” as a buffer address (Badd) for packet payload 3 based on the network identifier, the converted command identifier, and the offset. As described above, the context manager 142 may reflect the base address in the buffer address (Badd).

As described above, the data of packet payload 2 and the data of packet payload 3 for the same command, command 1, are based on the same base address, the same network identifier, and the same converted command identifier, so that the buffer addresses (Badd) are set. Therefore, the data of packet payload 2 and the data of packet payload 3 may be stored in a continuous space of the data buffer (DBF).

The host accelerator 143 may provide the data of packet payload 3 to a corresponding region of the data buffer (DBF) based on the buffer address (Badd). In the case of the embodiment of FIG. 7D, the host accelerator 143 may store the data of packet payload 3 at address “0x501000” of the data buffer (DBF).

Next, referring to FIGS. 1, 2, 6, and 7E, after receiving network packet 3 of network session 4, the first offload engine 120 may receive network packet 4 of network session 0 and output packet payload 4. Packet payload 4 may be a first type of packet payload including data together with a command. The command capsule handler 141 of the second offload engine 140 may store information about the command and data of packet payload 4 in the handling table (HTB).

FIG. 7E illustrates an example in which the remaining part of command 0 included in packet payload 4 is stored in the command field of the handling table (HTB) allocated to network session 0 so as to be added, and the data field is updated from offset “0” to the data size “4 kB” of packet payload 4.

Since command 0 is completely stored in the command field for network session 0 of the handling table (HTB), the command capsule handler 141 may deliver command 0 and offset “0” to the context manager 142. As described above, the command capsule handler 141 may process that command 0 is completely stored in the command field when the size of the command stored in the command field is greater than or equal to a preset size.

The command capsule handler 141 may provide the context manager 142 with identification information including a network identifier, a command identifier, and an offset corresponding to packet payload 4 and the data size of packet payload 4.

The context manager 142 may generate a buffer address (Badd) for packet payload 4 based on the identification information. FIG. 7E illustrates an example in which the context manager 142 generates “0x 10000” as a buffer address (Badd) for packet payload 4 based on the network identifier, the converted command identifier, and the offset. As described above, the context manager 142 may reflect the base address in the buffer address (Badd).

The host accelerator 143 may provide the data of packet payload 4 to a corresponding region of the data buffer (DBF) based on the buffer address (Badd). In the case of the embodiment of FIG. 7E, the host accelerator 143 may store the data of packet payload 4 at address “0x100000” of the data buffer (DBF).

Next, referring to FIGS. 1, 2, 6, and 7F, after receiving network packet 4 of network session 0, the first offload engine 120 may receive network packet 5 of network session 4 and output packet payload 5. Packet payload 5 may be a first type of packet payload including a command together with data. The command capsule handler 141 of the second offload engine 140 may store information about the command and data of packet payload 5 in the handling table (HTB).

FIG. 7F illustrates an example in which a part of command 2 is stored in the command field of the handling table (HTB) allocated to network session 4, and information about the size “4 kB” of the data included in packet payload 5 is additionally reflected in the data field. At this time, since packet payload 5 is the last packet payload for command 1, the data field can be reset to “0.”

The command capsule handler 141 may provide the context manager 142 with identification information corresponding to packet payload 5 and the data size “4 kB” of packet payload 5. Although FIG. 7F illustrates that the command capsule handler 141 also provides command 1 to the context manager 142, as described above, information already provided for command 1 may not be additionally provided to the context manager 142 for packet payload 5.

FIG. 7F illustrates an example in which the context manager 142 generates “0x503000” as a buffer address (Badd) for packet payload 5 based on the network identifier, the converted command identifier, and the offset. As described above, the context manager 142 may reflect the base address in the buffer address (Badd).

The host accelerator 143 may provide the data of packet payload 5 to a corresponding region of the data buffer (DBF) based on the buffer address (Badd). In the case of the embodiment of FIG. 7F, the host accelerator 143 may store the data of packet payload 5 at address “0x503000” of the data buffer (DBF).

As described above, the data of packet payload 5 may be stored continuously to the data of packet payload 3 in the data buffer (DBF).

When packet payload 5 is the last packet payload for command 1, the command capsule handler 141 may further provide the context manager 142 with a flush flag. In response to the flush flag, the context manager 142 may provide the host accelerator 143 with an SQE corresponding to command 1 being stored. The SQE provided to the host accelerator 143 by the context manager 142 may include command 1 and information about the size and address of the data buffer (DBF) for the region where data for command 1, in other words, the data of packet payload 2, packet payload 3, and packet payload 5, is stored.

Since data for the same command is stored in a continuous space of the data buffer (DBF) by the buffer addressing method of the present disclosure, the SQE provided to the host accelerator 143 includes a start address “0x500000” in the data buffer (DBF) where the data of packet payload 2 is stored and information about the total data size 16 kB of command 1.

The host accelerator 143 may provide the SQE corresponding to command 1 to a corresponding submission queue of the data buffer (DBF).

Next, referring to FIGS. 1, 2, 6, and 7G, after receiving network packet 5 of network session 1, the first offload engine 120 may receive network packet 6 of network session 0 and output packet payload 6. Packet payload 6 may be a first type of packet payload including only data. The command capsule handler 141 of the second offload engine 140 may store information about the data of packet payload 6 in the handling table (HTB).

FIG. 7G illustrates an example in which information about the size “4 kB” of the data included in packet payload 6 is additionally reflected in the data field of the handling table (HTB) allocated to network session 0. At this time, since packet payload 6 is the last packet payload for command 0, the data field may be reset to “0.”

The command capsule handler 141 may provide the context manager 142 with identification information corresponding to packet payload 6 and the data size “4 kB” of packet payload 6. Although FIG. 7G illustrates that the command capsule handler 141 also provides command 0 to the context manager 142, as described above, information already provided for command 0 may not be additionally provided to the context manager 142 for packet payload 6.

FIG. 7G illustrates an example in which the context manager 142 generates “0x101000” as a buffer address (Badd) for packet payload 6 based on the network identifier, the converted command identifier, and the offset. As described above, the context manager 142 may reflect the base address in the buffer address (Badd).

The host accelerator 143 may provide the data of packet payload 6 to a corresponding region of the data buffer (DBF) based on the buffer address (Badd). In the case of the embodiment of FIG. 7F, the host accelerator 143 may store the data of packet payload 6 at address “0x101000” of the data buffer (DBF).

When packet payload 6 is the last packet payload for command 0, the command capsule handler 141 may further provide the context manager 142 with a flush flag. In response to the flush flag, the context manager 142 may provide the host accelerator 143 with an SQE corresponding to command 0 being stored. The SQE provided to the host accelerator 143 by the context manager 142 may include command 0 and information about the size and address of the data buffer (DBF) for the region where data for command 0, in other words, the data of packet payload 4 and packet payload 6, is stored.

The host accelerator 143 may provide the SQE corresponding to command 0 to a corresponding submission queue of the data buffer (DBF). The submission queue in which the SQE corresponding to command 0 is stored may be the same as or different from the submission queue in which the SQE corresponding to command 1 is stored.

The host accelerator 143 may update the SQ doorbell value once for n SQEs when the SQE corresponding to packet payload 5 is the n^{th} (n is an integer of 2 or more) SQE stored in the submission queue or the SQE corresponding to packet payload 6 is the n^{th} SQE stored in the submission queue. Since the value of the SQ doorbell is updated only once when n SQEs are stored in the submission queue corresponding to each storage device and the value of the SQ doorbell is not updated whenever each SQE is stored in the submission queue, the number of times the SQ doorbell needs to be delivered to the storage device (STD) is reduced to 1/n, or n SQEs may be delivered to the storage device at once. Therefore, traffic between the second offload engine 140 and the storage device may be reduced.

In the above description, command 0 and command I may be write commands. On the other hand, command 2 may be a read command. Command 2 may be included in packet payload 5 and, although not shown, packet payload 7 and delivered to the second offload engine 140.

In FIG. 7G, after the SQE for command 0 is written to the corresponding submission queue in the data buffer (DBF) by processing packet payload 6, the second offload engine 140 receives a packet payload 7 corresponding to network packet 7 of network session 4 from the first offload engine 120. Packet payload 7 may be a second type of packet payload composed of only a command. The command capsule handler 141 may add the remaining part of command 2 of packet payload 7 to the command field of the handling table (HTB) for network session 4 in addition to a part of command 2 included in packet payload 5. Accordingly, the size of command 2 in the corresponding command field becomes greater than or equal to a preset size, so that the command capsule handler 141 may deliver the SQE including command 2 to the context manager 142 together with a flush flag.

Before delivering the SQE to the host accelerator 143, the context manager 142 may set a buffer address (Badd) of a region in the data buffer (DBF) where data to be read from the storage device (STD) will be stored later based on the network identifier, the command identifier included in the SQE, and information about the size of data to be read. The context manager 142 may generate the buffer address by converting the command identifier corresponding to the size of the submission queue, like the operation of generating data identifiers for packet payload 2 to packet payload 5.

The buffer address of the region where data to be read from the storage device (STD) will be stored later may be included in the SQE of command 2 by the context manager 142 and stored in the submission queue. By the buffer addressing method described above, data read from the storage device (STD) corresponding to the same read command may be stored in a continuous region of the data buffer (DBF).

As described above, according to the NVMe-oF target accelerating apparatus 100 and the system 1000 including the same according to embodiments of the present disclosure, the processing performance of network packets (NPKs) may be improved by including the first offload engine 120 and the second offload engine 140. According to the NVMe-oF target accelerating apparatus 100 and the system 1000 including the same according to embodiments of the present disclosure, the processing performance of network packets (NPKs) may be improved by the second offload engine 140 processing packet payloads (PPLs) in real time without waiting for packet payloads to be provided later when the packet payloads (PPLs) are provided from the first offload engine 120. According to the NVMe-oF target accelerating apparatus 100 and the system 1000 including the same according to embodiments of the present disclosure, the processing performance of network packets (NPKs) may be improved by efficiently performing addressing to the data buffer (DBF) by generating a data identifier by converting a command identifier. According to the NVMe-oF target accelerating apparatus 100 and the system 1000 including the same according to embodiments of the present disclosure, traffic in the process of delivering SQEs to the storage device (STD) may be reduced by updating an SQ doorbell when n SQEs are stored in one submission queue.

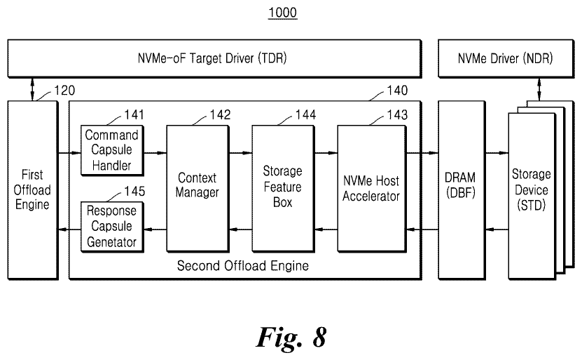

FIG. 8 is a diagram illustrating the system 1000 including the NVMe-oF target accelerating apparatus 100 according to an embodiment of the present disclosure.

Referring to FIGS. 1, 6, and 8, the system 1000 including the NVMe-oF target accelerating apparatus 100 according to an embodiment of the present disclosure may include the NVMe-oF target accelerating apparatus 100, a data buffer (DBF), and a storage device (STD). In addition, although not shown, the system 1000 of FIG. 8 may further include a CPU or a system bus as in FIG. 3 or 4.

The NVMe-oF target accelerating apparatus 100 of FIG. 8 may include the first offload engine 120 and the second offload engine 140 implemented by hardware. As in FIG. 5, the second offload engine 140 may include the command capsule handler 141, the context manager 142, and the host accelerator 143, and may further include a storage feature box 144 and a response capsule generator 145.

In this case, in the NVMe-oF target accelerating apparatus 100 according to an embodiment of the present disclosure, the command capsule handler 141, the context manager 142, the storage feature box 144, and the host accelerator 143 are involved in processing a command, and the host accelerator 143, the storage feature box 144, the context manager 142, and the response capsule generator 145 are involved in processing completion for the command.

This will be described in detail below. However, parts overlapping with the previous description may be briefly described. The operations described below assume a case for a write command unless otherwise specified, and in the case of other commands, the operations may be performed in the same manner except for processing for data.

When a packet payload (PPL) including data is provided from the first offload engine 120, the command capsule handler 141 may process the packet payload (PPL) in real time without waiting for packet payloads to be provided later and provide the processed packet payload (PPL) to the context manager 142. In one embodiment, the command capsule handler 141 may process packet payloads (PPLs) in the order in which the packet payloads (PPLs) are provided instead of waiting until all data is provided for one write command.

The context manager 142 may store information necessary in a later completion processing process among information provided from the command capsule handler 141. In one embodiment, the context manager 142 may store the information in a register provided internally or externally in the form of an array. In one embodiment, the context manager 142 may perform indexing on the array of information using a network identifier and a command identifier of an SQE.

In one embodiment, while the command identifier of the SQE in each NVMe-oF queue (submission queue or the like) is a unique value in the corresponding queue, NVMe-oF queues of different network sessions may have the same value. By using the network identifier and the command identifier together for indexing, it may be possible to determine which network session a command is processed for in generating a response capsule during a completion processing process for the command, which will be described later.

As described above, since the command identifier has a wide value range and does not increase sequentially, the command identifier may not be suitable for use in indexing. Therefore, the context manager 142 according to an embodiment of the present disclosure may use the command identifier of the SQE by converting the command identifier to one of “0” to “y−1” (y is the size of the submission queue).

The command identifier included in the SQE may be updated to the converted command identifier. In addition, a buffer address (Badd) of data related to the SQE as an address for the data buffer (DBF) may be stored in the SQE. In one embodiment, the buffer address may include a start value among buffer addresses where data related to the SQE is stored and information about the size of all data for the command.

The context manager 142 may provide the updated SQE, related data, and information about a submission queue corresponding to the SQE (queue identifier) to the storage feature box 144.

The storage feature box 144 may perform processing for improving functions of the storage device (STD) on the SQE or data. In one embodiment, the storage feature box 144 may perform processing for improving efficiency and security of data storage and management in the storage device (STD). In one embodiment, the storage feature box 144 may perform processing such as deduplication, data compression and encryption, redundant array of independent disks (RAIDs), and erasure coding on the SQE or data according to needs of the system 1000. The storage feature box 144 may deliver the processed SQE and data to the host accelerator 143.

The host accelerator 143 may transmit data to a region corresponding to the buffer address (Badd) in the data buffer (DBF). In addition, the host accelerator 143 may calculate an address of a queue where the SQE should be added in the submission queue of the data buffer (DBF), in other words, an address of a submission queue for a storage device (STD) to which the SQE should be delivered.

A submission queue and a completion queue for each storage device (STD) may be provided in the data buffer (DBF). However, the present disclosure is not limited thereto, and the submission queue and the completion queue may be provided in a memory located in the NVMe-OF target accelerating apparatus 100 instead of the data buffer (DBF).

The host accelerator 143 may update an SQ doorbell when preset n SQEs are stored in the submission queue. Therefore, the number of times SQEs are delivered to the storage device (STD) is reduced to 1/n, so that traffic (for example, PCIe traffic) with the storage device (STD) may be reduced.

In one embodiment, when the data buffer (DBF) is provided in the NVMe-oF target accelerating apparatus 100, the storage device (STD) corresponding to the submission queue in which the SQ doorbell is updated may process I/O by exchanging SQEs and data without intervention of the CPU using a PCIe peer-to-peer (P2P) function. The storage device (STD) may read the SQE stored in the submission queue, perform a corresponding operation, and provide a CQE, which is a result, to the completion queue.

In one embodiment, when the SQE includes a write command, the storage device (STD) may access data of the data buffer (DBF) based on the address included in the SQE, write the corresponding data to the storage device (STD), and provide a CQE to the completion queue. The CQE may include a command identifier, metadata about whether an operation is successful or failed, and the like.

In one embodiment, when the SQE includes a read command, the storage device (STD) may store read data in the data buffer (DBF) based on the address included in the SQE and provide a CQE to the completion queue.

When a CQE is stored in the completion queue, the host accelerator 143 may read the CQE from the completion queue and deliver the CQE to the storage feature box 144. In the case of a CQE for a read command, the host accelerator 143 may read data from a region corresponding to the buffer address in the data buffer (DBF) and provide the data to the storage feature box 144 together with the CQE.

In one embodiment, when there is a CQE write request for a CQE from the storage device (STD), the host accelerator 143 may check a completion queue corresponding to the address included in the CQE write request and deliver an identifier of the corresponding completion queue to the storage feature box 144 together with the CQE.

To this end, the host accelerator 143 may include a CQE buffer. Specifically, when a CQE write request is received from the storage device (STD), the host accelerator 143 may store the CQE in the CQE buffer and determine which completion queue of which storage device (STD) the CQE write request is for from the address included in the CQE write request. The address included in the CQE write request may include information about which queue of which storage device (STD) the CQE write request is for, like the buffer address included in the SQE.

In one embodiment, the host accelerator 143 may allocate a region of the CQE buffer corresponding to the product of the size of the completion queue and the number of completion queues, store CQEs in the order in which the CQEs are delivered, and sequentially process the CQEs. Therefore, the host accelerator 143 according to an embodiment of the present disclosure may improve processing performance even with a CQE buffer having a relatively small size.

After that, the host accelerator 143 may update a CQ doorbell to notify the storage device (STD) that the CQE has been processed. In one embodiment, the host accelerator 143 may reduce PCIe traffic by delivering one CQ doorbell to the storage device (STD) after m (m is an integer of 2 or more) CQEs are processed.

The storage feature box 144 may recover processing performed on the SQE and/or data before delivering the SQE and/or data to the storage device (STD). In one embodiment, the storage feature box 144 may perform data decompression processing on the CQE and data delivered from the storage device (STD) to which data compression is applied, and perform decryption processing on the CQE and data delivered from the storage device (STD) to which encryption is applied. The storage feature box 144 may provide the recovered CQE and data to the context manager 142.

The context manager 142 may convert the context of the CQE provided from the storage feature box 144 and provide the CQE to the response capsule generator 145 together with data. In one embodiment, the context manager 142 may return the converted command identifier to the original state before conversion. In one embodiment, the context manager 142 may convert an NVMe queue identifier (for example, SQ ID or CQ ID) to a network session identifier using mapping information about a network session identifier and the NVMe queue identifier delivered in an initialization process. The NVMe-oF target accelerating apparatus 100 according to an embodiment of the present disclosure may select an NVMe queue identifier that is not in use from a freelist and map the NVMe queue identifier to a network session identifier whenever an NVMe connection occurs. The context manager 142 may use information stored in the process of processing the SQE to convert the context of the CQE.

The response capsule generator 145 may convert the CQE to a response capsule and provide the response capsule to the first offload engine 120. In the case of a CQE for a read command, the CQE for one command and all data related to the corresponding command may be converted to one response capsule.

In one embodiment, the response capsule generator 145 may transmit a packet transmission request to the first offload engine 120. In response to the packet transmission request, when the first offload engine 120 may output a response packet (RPK) to the network, the first offload engine 120 may transmit a packet data request including information about the size of data that may be included in the response packet (RPK) to the response capsule generator 145.

The packet data request may include one or more response capsules or only a part of one response capsule. In the former case, the response capsule generator 145 may provide one or more response capsules to the first offload engine 120 as a response payload (RPL). In the latter case, the response capsule generator 145 may provide the response capsule divided into a size corresponding to the packet data request to the first offload engine 120 as a response payload (RPL).

As described above, in the NVMe-oF target accelerating apparatus 100 according to an embodiment of the present disclosure, the first offload engine 120 generates a packet data request having a size adaptive to a network state, and the second offload engine 140 delivers a response payload (RPL) to the first offload engine 120 in response to the packet data request, thereby improving processing performance. The first offload engine 120 may set the size of the response packet (RPK) differently according to the network state.

The first offload engine 120 may receive the response payload (RPL) and generate a response packet (RPK) by adding a header according to a network protocol corresponding to the response payload (RPL). The response packet (RPK) may be transmitted to the initiator (INT) of FIG. 2 through the network.

In preparation for retransmission that may occur due to network characteristics, the second offload engine 140 may maintain data and information stored in the data buffer (DBF) and the register until a signal indicating completion of transmission of the response packet (RPK) is received from the first offload engine 120. In one embodiment, the context manager 142 of the second offload engine 140 may include a register for storing a buffer address generated by reflecting the converted command identifier until transmission of the response packet (RPK) for the network packet is successful.

The NVMe-oF target accelerating apparatus 100 and the system 1000 according to embodiments of the present disclosure have been described above with respect to an example in which a hardware interface, in other words, a network packet (NPK), is provided from the first offload engine 120 to the second offload engine 140, which is hardware. In one embodiment, such a hardware interface may operate when the network packet (NPK) is related to an I/O command.

The NVMe-oF target accelerating apparatus 100 may further include an NVMe-oF target driver (TDR) implemented by software, together with the first offload engine 120 and the second offload engine 140 implemented by hardware. According to one embodiment, when the network packet (NPK) is related to an admin command or a fabric command, the first offload engine 120 may provide the network packet (NPK) through a software interface in the NVMe-oF target accelerating apparatus 100 and the system 1000. In other words, the network packet (NPK) may be provided to the NVMe-oF target driver (TDR) implemented by software.

The NVMe-oF target driver (TDR) may perform initialization of the NVMe-OF target accelerating apparatus 100 and control related to NVMe-oF. In one embodiment, the NVMe-oF target driver (TDR) may perform the following initialization operation and control operation.

### Initialization Operation

Initializing register values for the SQ doorbell and CQ doorbell of each storage device (STD), and setting a limit value for the size of each doorbell
Setting a base address of the data buffer
Creating an NVMe queue (submission queue and completion queue) for each storage device (STD)
Initializing data buffer for setting a PRP list

According to the NVMe-oF protocol, a PRP list must be used to deliver data larger than 8 kB to the storage device (STD). The PRP list is for addresses of the data buffer (DBF) where data is stored, and the PRP list may also be stored in the data buffer (DBF). As described above, since the NVMe-oF target accelerating apparatus 100 according to an embodiment of the present disclosure may store data in a continuous region of the data buffer (DBF), all possible addresses are written in the PRP list in the initialization stage, and when a command is delivered to the storage device (STD), only a pointer to the PRP list needs to be changed, and the PRP list itself may not be updated for each command.

Therefore, the NVMe-oF target accelerating apparatus 100 according to an embodiment of the present disclosure does not need to access the data buffer (DBF) to update the PRP list, thereby reducing memory bandwidth.

### NVMe-oF Control

Setting network session and NVMe queue mapping for the operation of the context manager for an “NVMe connect” command
Switching a software interface to a hardware interface when a network packet for an I/O command is received

In one embodiment, for a system that does not use the NVMe protocol, all network packets (NPKs) may be processed by a software interface without the operation of the second offload engine 140.

The system 1000 according to an embodiment of the present disclosure may further include an NVMe driver (NDR) implemented by a software driver to perform operations such as queue creation and admin command processing for the storage device (STD).

The NVMe-oF target driver (TDR) and the NVMe driver (NDR) may be located in the NVMe-oF target accelerating apparatus 100 or included outside the NVMe-oF target accelerating apparatus 100 (for example, in the CPU).

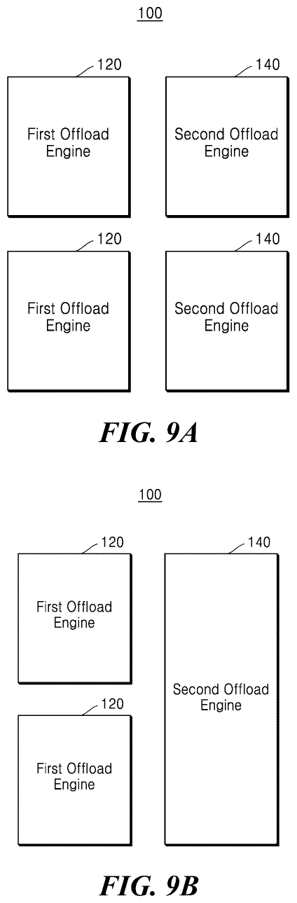

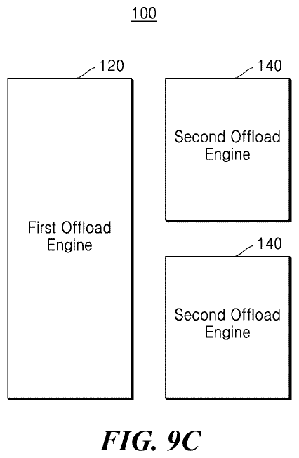

FIGS. 9A to 9C are diagrams each illustrating the NVMe-oF target accelerating apparatus 100 according to an embodiment of the present disclosure.

Referring to FIGS. 2, 9A to 9C, the NVMe-OF target accelerating apparatus 100 according to an embodiment of the present disclosure may process network packets (NPKs) and response packets (RPKs) in various ways as necessary in addition to transmitting/receiving network packets (NPKs) and response packets (RPKs) with the initiator (INT) through the pair of first offload engine 120 and second offload engine 140 described above.

In one embodiment, the NVMe-oF target accelerating apparatus 100 may process network packets (NPKs) through two or more pairs of first offload engine 120 and second offload engine 140 (FIG. 9A). In one embodiment, in the NVMe-oF target accelerating apparatus 100, two or more first offload engines 120 may share one second offload engine 140 (FIG. 9B), or two or more second offload engines 140 may share one first offload engine 120 (FIG. 9C).

In one embodiment, two or more first offload engines 120 or two or more second offload engines 140 of FIGS. 9A to 9C may share some hardware logic or the NVMe-oF target driver (TDR) of FIG. 8, respectively. In one embodiment, one or more of the two or more first offload engines 120 may operate as a main first offload engine, and the rest may operate as a spare. Similarly, one or more of the two or more second offload engines 140 may operate as a main second offload engine, and the rest may operate as a spare.

Therefore, the NVMe-oF target accelerating apparatus 100 according to an embodiment of the present disclosure may increase the processing capacity or processing speed for network packets (NPKs) or prevent a bottleneck phenomenon caused by one of the first offload engine 120 and the second offload engine 140. Alternatively, the NVMe-oF target accelerating apparatus 100 according to an embodiment of the present disclosure may prepare for a network error or an error of the offload engine.

An NVMe-oF target accelerating apparatus according to an embodiment of the present disclosure includes, a first offload engine configured to offload a network stack to compute a first network packet and output a first packet payload; and a second offload engine configured to offload a non-volatile memory express over fabrics (NVMe-oF) stack to compute the first packet payload and output data having a first buffer address when the first packet payload is of a first type.

When receiving a second packet payload for a second network packet from the first offload engine after receiving the first packet payload, the second offload engine may compute the second packet payload and output data having a second buffer address when the second packet payload is of the first type.

The second offload engine may include, a command capsule handler configured to output identification information including a command identifier of a command capsule; a context manager configured to generate the first buffer address based on the identification information when the first packet payload is a first type of packet payload; and a host accelerator configured to provide the data to a corresponding region of a data buffer based on the first buffer address.

The command capsule handler may include a handling table configured to store information about a command and data of the first packet payload.

The command capsule handler may output a flush flag when the size of the command stored in the command field of the handling table is greater than or equal to a preset size.

The context manager may generate the first buffer address by converting the command identifier to a value corresponding to the size of a submission queue in which a first submission queue entry (SQE) of the command capsule is stored.

The context manager may provide the host accelerator with a first SQE corresponding to the first packet payload when a flush flag is received from the command capsule handler.

The host accelerator may provide the first SQE to a corresponding submission queue, and update a doorbell value once for n (n is an integer of 2 or more) SQEs when the first SQE is the n^{th} SQE stored in the SQ.

The second offload engine may further include a storage feature box configured to compress or encrypt data of the first packet payload.

The second offload engine may further include a response capsule generator configured to convert a first completion queue entry (CQE) for a first SQE of the first packet payload to a response capsule, and provide the response capsule to the first offload engine as a response payload in response to a packet data request.

The response payload may be generated to include one or more response capsules or a part of one response capsule.

The first offload engine may be shared by at least two second offload engines.

The second offload engine may be shared by at least two first offload engines.

A method of operating an NVMe-oF target accelerating apparatus according to an embodiment of the present disclosure includes, receiving, by a first offload engine, a first network packet for a storage device to output a first packet payload; and extracting, by a second offload engine, a command capsule from the first packet payload, and storing data of the first packet payload in a region corresponding to the first buffer address of a data buffer when the first packet payload is of a first type.

The method may further include, storing, by the second offload engine, data of a second packet payload for the same command as the first packet payload continuously to a region where data of the first packet payload is stored in the data buffer.

The method may further include, generating, by the second offload engine, a response capsule including a first CQE corresponding to the first SQE provided from the storage device; generating, by the second offload engine, a response payload including one or more response capsules or a part of one response capsule; and outputting, by the first offload engine, the response payload as a response packet.

A system including an NVMe-oF target accelerating apparatus according to an embodiment of the present disclosure includes, an NVMe-OF target accelerating apparatus including a first offload engine configured to offload a network stack to compute a network packet and output a first packet payload, and a second offload engine configured to offload an NVMe-OF stack to compute the first packet payload and output data having a first buffer address when the first packet payload is of a first type; and a plurality of storage devices configured to perform input/output corresponding to the first SQE and provide an input/output result to the NVMe-oF target accelerating apparatus as a first CQE.

The system may further include a system memory in which the first SQE and the first CQE are stored.

The NVMe-oF target accelerating apparatus may further include a data buffer in which the first SQE and the first CQE are stored.

The system may further include an NVMe-OF driver configured to receive and process the first packet payload from the first offload engine when the network packet includes an admin command or a fabrics command, and switch so that the first packet payload is provided to the second offload engine when the network packet includes an I/O Command.

The various embodiments of the present disclosure and the terms used in the embodiments are not intended to limit the technical features described in the present disclosure to specific embodiments, and should be understood to include various modifications, equivalents, or alternatives of the embodiments. For example, a component expressed in the singular should be understood as a concept including a plurality of components unless the context clearly indicates that only the singular is meant. It is to be understood that the term “and/or” as used in this disclosure is intended to encompass any and all possible combinations of one or more of the items listed.

The terms “include,” “have,” “be composed of,” and the like used in this disclosure are only intended to specify the presence of the features, components, parts, or a combination thereof described in this disclosure, and are not intended to exclude the presence or addition of one or more other features, components, parts, or combinations thereof by the use of such terms. In this disclosure, each of the phrases such as “A or B,” “at least one of A and B,” “at least one of A or B,” “A, B or C,” “at least one of A, B and C,” and “at least one of A, B, or C” may include any one of the items listed together in the corresponding phrase among the phrases, or all possible combinations thereof. Terms such as “first,” “second,” or “first” or “second” may be used simply to distinguish the component from another corresponding component, and do not limit the components in other aspects (for example, importance or order).

The term “˜unit,” “˜block,” “˜logic” or “˜module” used in various embodiments of the present disclosure may include a unit implemented by hardware, software or firmware, and for example, may be used interchangeably with terms such as logic, logic block, component, or circuit. The “˜unit,” “˜block,” “˜logic” or “˜module” may be an integral component, or the minimum unit or a part of the component that performs one or more functions. For example, according to one embodiment, the “˜unit,” “˜block,” “˜logic” or “˜module” may be implemented in the form of an application-specific integrated circuit (ASIC) or a field-programmable gate array (FPGA).

The term “when ˜” used in various embodiments of the present disclosure may be interpreted to mean “when,” “at the time of,” “in response to determining,” or “in response to detecting” depending on the context. Similarly, “if ˜ is determined” or “if ˜ is detected” may be interpreted to mean “at the time of determination” or “in response to determining,” or “at the time of detection” or “in response to detecting” depending on the context.

The programs executed in the NVMe-oF target accelerating apparatus and the system including the same described through the present disclosure may be implemented by hardware components, software components, and/or a combination of hardware components and software components. The programs may be executed by any system capable of executing computer-readable instructions.

Software may include a computer program, code, instructions, or a combination of one or more thereof, and may configure a processing device to operate as desired or command the processing device independently or collectively. Software may be implemented as a computer program including instructions stored on a computer-readable storage medium. Examples of the computer-readable storage medium include a magnetic storage medium (for example, read-only memory (ROM), random-access memory (RAM), floppy disk, hard disk, etc.) and an optical reading medium (for example, CD-ROM, digital versatile disc (DVD)).

The computer-readable storage medium may be distributed over networked computer systems so that computer-readable code is stored and executed in a distributed manner. The computer program may be distributed (for example, downloaded or uploaded) online through an application store (for example, Play Store™) or directly between two user devices (for example, smart phones). In the case of online distribution, at least a portion of the computer program product may be at least temporarily stored in a device-readable storage medium such as a memory of a manufacturer's server, an application store's server, or a relay server, or may be temporarily generated.

According to various embodiments of the present disclosure, each component of the components described above (for example, module or program) may include a single or plural entities, and some of the plural entities may be separately arranged in other components. According to various embodiments, one or more of the aforementioned corresponding components or operations may be omitted, or one or more other components or operations may be added. Alternatively or additionally, a plurality of components (for example, modules or programs) may be integrated into one component. In this case, the integrated component may perform one or more functions of each of the plurality of components in the same or similar manner as performed by the corresponding component among the plurality of components before the integration. According to various embodiments, the operations performed by the modules, programs, or other components may be executed sequentially, in parallel, repeatedly, or heuristically, or one or more of the operations may be executed in a different order, omitted, or one or more other operations may be added. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A non-volatile memory express over fabrics (NVMe-oF) target accelerating apparatus comprising:
a first offload engine configured to offload a network stack to compute a first network packet and output a first packet payload; and
a second offload engine configured to offload an NVMe-oF stack to compute the first packet payload and output data having a first buffer address when the first packet payload is of a first type.

2. The NVMe-oF target accelerating apparatus of claim 1, wherein when receiving a second packet payload for a second network packet from the first offload engine after receiving the first packet payload, the second offload engine computes the second packet payload, and outputs data having a second buffer address when the second packet payload is of the first type.

3. The NVMe-oF target accelerating apparatus of claim 1, wherein the second offload engine includes:
a command capsule handler configured to output identification information including a command identifier of a command capsule;
a context manager configured to generate the first buffer address based on the identification information when the first packet payload is of the first type; and
a host accelerator configured to provide the data to a corresponding region of a data buffer based on the first buffer address.

4. The NVMe-oF target accelerating apparatus of claim 3, wherein the command capsule handler includes a handling table configured to store information about a command and data of the first packet payload.

5. The NVMe-oF target accelerating apparatus of claim 4, wherein the command capsule handler outputs a flush flag when the size of the command stored in the command field of the handling table is greater than or equal to a preset size.

6. The NVMe-oF target accelerating apparatus of claim 3, wherein the context manager generates the first buffer address by converting the command identifier to a value corresponding to the size of a submission queue in which a first submission queue entry (SQE) of the command capsule is stored.

7. The NVMe-oF target accelerating apparatus of claim 3, wherein the context manager provides the host accelerator with a first SQE corresponding to the first packet payload when a flush flag is received from the command capsule handler.

8. The NVMe-oF target accelerating apparatus of claim 7, wherein the host accelerator provides the first SQE to a corresponding submission queue, and updates a doorbell value once for n SQEs when the first SQE is the n^{th} SQE stored in the SQ, and
wherein n is an integer greater than or equal to 2.

9. The NVMe-oF target accelerating apparatus of claim 3, wherein the second offload engine further includes a storage feature box configured to compress or encrypt data of the first packet payload.

10. The NVMe-oF target accelerating apparatus of claim 3, further comprising a response capsule generator configured to convert a first completion queue entry (CQE) for a first SQE of the first packet payload to a response capsule, and provide the response capsule to the first offload engine as a response payload in response to a packet data request.

11. The NVMe-oF target accelerating apparatus of claim 10, wherein the response payload is generated to include one or more response capsules or a part of one response capsule.

12. The NVMe-oF target accelerating apparatus of claim 1, wherein the first offload engine is shared by at least two second offload engines.

13. The NVMe-oF target accelerating apparatus of claim 1, wherein the second offload engine is shared by at least two first offload engines.

14. A method of operating an NVMe-oF target accelerating apparatus, the method comprising:
receiving, by a first offload engine, a first network packet for a storage device to output a first packet payload; and
extracting, by a second offload engine, a command capsule from the first packet payload, and storing data of the first packet payload in a region corresponding to the first buffer address of a data buffer when the first packet payload is of a first type.

15. The method of claim 14, further comprising:
storing, by the second offload engine, data of a second packet payload for the same command as the first packet payload continuously to a region where data of the first packet payload is stored in the data buffer.

16. The method of claim 14, further comprising:
generating, by the second offload engine, a response capsule including a first CQE corresponding to the first SQE provided from the storage device;
generating, by the second offload engine, a response payload including one or more response capsules or a part of one response capsule; and
outputting, by the first offload engine, the response payload as a response packet.

17. A system comprising:
an NVMe-oF target accelerating apparatus including a first offload engine configured to offload a network stack to compute a network packet and output a first packet payload, and a second offload engine configured to offload an NVMe-oF stack to compute the first packet payload and output data having a first buffer address when the first packet payload is of a first type; and
a plurality of storage devices configured to perform input/output corresponding to the first SQE and provide an input/output result to the NVMe-oF target accelerating apparatus as a first CQE.

18. The system of claim 17, further comprising a system memory in which the first SQE and the first CQE are stored.

19. The system of claim 17, wherein the NVMe-oF target accelerating apparatus further includes a data buffer in which the first SQE and the first CQE are stored.

20. The system of claim 17, further comprising an NVMe-oF driver configured to receive and processes the first packet payload from the first offload engine when the network packet includes an admin command or a fabrics command, and switches so that the first packet payload is provided to the second offload engine when the network packet includes an I/O Command.
